(19) United States
(12) Patent Application Publication
(10) Pub. No.: US 2021/0270266 A1
(43) Pub. Date: Sep. 2, 2021

(54) ROTARY VANE PUMP

(71) Applicant: FTE AUTOMOTIVE GmbH, Ebern (DE)

(72) Inventor: Wilhelm HEUBNER, Ebern (DE)

(73) Assignee: FTE AUTOMOTIVE GmbH, Ebern (DE)

(21) Appl. No.: 17/181,036

(22) Filed: Feb. 22, 2021

(30) Foreign Application Priority Data
Feb. 27, 2020 (DE) 10 2020 105 172.7

(51) Int. Cl. F04C 2/348

(52) U.S. Cl. CPC F04C 2/348; F04C 15/008

(57) ABSTRACT

A rotary vane pump having a stator and having a rotor in which at least one rotary vane is received. A radially outer side of the rotary vane serves for delimiting a low-pressure chamber. A radially inner side of the rotary vane serves for delimiting a high-pressure chamber.

The invention relates to a rotary vane pump, such as can be used in particular as an auxiliary unit in a drive train of a motor vehicle, for providing a hydraulic flow by way of which other components can be lubricated, cooled and/or actuated.

Rotary vane pumps are generally known. They may be designed as a blade cell pump or roller cell pump, and they have a stator within which a rotor is arranged. The rotor normally receives a plurality of the rotary vanes such that said rotary vanes are adjustable in an (at least approximately) radial direction and bear with their outer side against an inner wall of the stator. When the rotor is rotated, a pump chamber which is delimited between two adjacent rotary vanes, the outer wall of the rotor and the inner wall and side walls of the stator has a varying volume. This change in volume is used for drawing a hydraulic fluid through an intake opening, which is arranged at a suitable position, and for delivering said hydraulic fluid at a higher pressure to a suitably arranged outlet opening.

Rotary vane pumps, like almost all other pumps, are also matched to a specific operating state. If they are matched such that, by way of the hydraulic flow provided by them, for example a clutch actuator can be switched, the volume flow is so small that other tasks, for example the supply of lubricant for a gearbox, cannot be performed. Conversely, a rotary vane pump which is designed for supplying lubricant to a gearbox or for providing a coolant flow for a clutch normally cannot generate the desired high pressure that is required for actuating a clutch actuator.

WO 2012/045164 A1 has disclosed a rotary vane pump in which provision is made of two differently formed pump chambers in order to provide a high-pressure fluid flow and a low-pressure fluid flow using a stator and a rotor. However, even with such a pump, it is not possible to provide fluid flows having highly different characteristics.

For this reason, use is often made of two separate auxiliary units, specifically a low-pressure pump, which delivers a large volume flow at low operating pressure (for example of the order of magnitude of 10 l/min at 4 bar), and a high-pressure pump, which delivers a small volume flow at high operating pressure (for example of the order of magnitude of 1 l/min at 40 bar).

It is the object of the invention to reduce the outlay in terms of construction that is necessary for supplying, in a respectively suitable manner, different units with hydraulic fluid.

For the purpose of achieving said object, provision is made according to the invention of a rotary vane pump having a stator and having a rotor in which at least one rotary vane is received, wherein a radially outer side of the rotary vane serves for delimiting a low-pressure chamber, and wherein a radially inner side of the rotary vane serves for delimiting a high-pressure chamber. The invention is based on the fundamental concept of using the rotary vane with a dual function: Said rotary vane delimits together with the inner wall of the stator a pressure chamber, which is a low-pressure chamber here and whose volume between two adjacent rotary vanes changes during the rotation of the rotor. Furthermore, the rotary vane acts as a pump piston, which delimits a pump chamber with variable volume within the rotor, said pump chamber serving as a high-pressure chamber. Here, the changing of the volumes of the high-pressure chamber and the low-pressure chamber takes place in an (approximately) parallel manner: When the rotary vane is adjusted outwards relative to the rotor, the volume of the high-pressure chamber increases, and the volume of the low-pressure chamber will generally increase too (depending on the specific geometrical conditions of the inner wall of the stator). The particular advantage of the rotary vane pump according to the invention is that the delivery pressure and the delivery volume of the high-pressure pump can be set in a manner almost independent of the delivery volume and delivery pressure of the low-pressure pump, specifically by changing the thickness of the rotary vane. For the same drive torque, a smaller thickness results in a smaller delivery volume and a potentially higher possible delivery pressure. However, a change in the thickness of the rotary vane has almost no effect on the delivery characteristics of the low-pressure pump. Overall, a pump which combines a low-pressure pump and a high-pressure pump and has both a high-pressure outlet and a low-pressure outlet is provided in this way.

According to one configuration of the invention, it is provided that the stator has two side walls, and that, in at least one of the side walls, provision is made of a high-pressure outlet opening, which is assigned to the high-pressure chamber. In this configuration, the hydraulic fluid displaced by the radially inner side of the rotary vanes can be discharged directly laterally from the rotor.

According to one configuration of the invention, it may be provided that, in at least one of the side walls, provision is made of an inlet opening, which is assigned to both the low-pressure chamber and the high-pressure chamber. The joint provision of a supply to the suction side of the low-pressure pump and of the high-pressure pump results in a structurally simple design.

It may alternatively be provided that, in at least one of the side walls, provision is made of a high-pressure inlet opening, which is assigned exclusively to the high-pressure chamber, wherein provision is made of a low-pressure inlet opening, which is separate from the high-pressure inlet opening and is assigned exclusively to the low-pressure chamber. Separate inlet openings for the high-pressure pump and the low-pressure pump make it possible to adapt the intake conditions to the respective characteristics more effectively.

In principle, it is possible for the low-pressure inlet opening to be provided in the inner wall of the stator. Preferably, however, the low pressure inlet opening is provided in at least one of the side walls, which offers advantages with regard to wear.

According to one configuration of the invention, a branch leads from a low-pressure outlet opening to the high-pressure inlet opening. In this way, the hydraulic fluid does not have to be drawn into the high-pressure chambers by the rotary vanes, but rather the high-pressure chambers are provided with said hydraulic fluid at a slight positive pressure. Said positive pressure also promotes the abutment of the rotary vanes against the inner wall of the stator at low rotational speeds.

Expressed in more general terms, it may be provided that the rotary vane pump has a single high-pressure outlet and a single low-pressure outlet, that is to say is of single-flow or single-stroke design. Specifically, in such a rotary vane pump, it is provided that the stator has an inner wall whose radius, as seen in a cross section of the stator and with respect to the axis of rotation of the rotor, increases from a minimum to a maximum, and then decreases again to the minimum, in the circumferential direction, wherein, as seen over an angle of 360°, there is exactly one minimum and exactly one maximum. In other words, the inner wall of the stator, as seen in cross section, may be circular, and the rotor is arranged eccentrically with respect to the central axis of the circular shape of the inner wall.

It is also possible for the rotary vane pump to have two high-pressure outlets and two low-pressure outlets, that is to say to be of two-flow or double-stroke design. This may be achieved in that the inner wall, as seen in a cross section, has an elongate or constricted shape, wherein the axis of rotation of the rotor is arranged approximately centrally on the smaller diameter or in the constricted region. In other words, the stator has an inner wall whose radius, as seen in a cross section of the stator and with respect to the axis of rotation of the rotor, increases from a minimum, then decreases again, then increases again, and then decreases once more, over an angle of 360° in a revolution in the circumferential direction. Such a pump may provide a supply to multiple mutually independent actuators.

According to one configuration of the invention, it is provided that provision is made of a common inlet opening for two pump chambers, which extends on a side wall, diametrically from one side to the other side. Apart from a reduction in the complexity of the feeding of the hydraulic fluid, the advantage is obtained that, by way of such an inlet opening, it is possible to collect the leakage flows at a face side of the rotor, whereby the pressure acting on the rotor in the axial direction is reduced.

The rotary vanes of the rotary vane pump may have different designs depending on the respective embodiments. For example, use may be made of cylinders, if said rotary vane pump is a roller cell pump, or plates, if it is a rotary blade pump.

According to one configuration of the invention, it is provided that provision is made of five or more rotary vanes, in order to keep the pressure pulsations of the rotary vane pump as low as possible.

The invention will be described below on the basis of various embodiments, which are illustrated in the appended drawings. In these drawings:

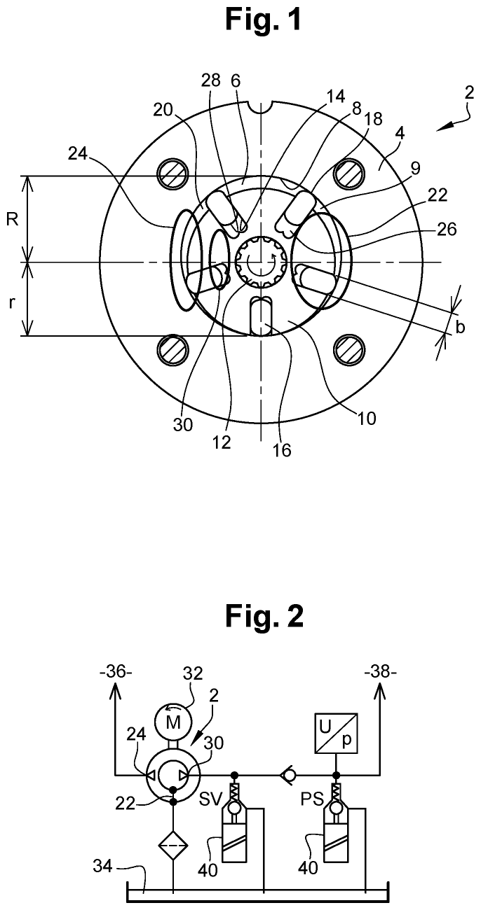

FIG. 1 shows, in a cross section, a rotary vane pump according to a first embodiment of the invention;

FIG. 2 shows, in a hydraulic circuit diagram, the rotary vane pump according to the first embodiment in an exemplary application;

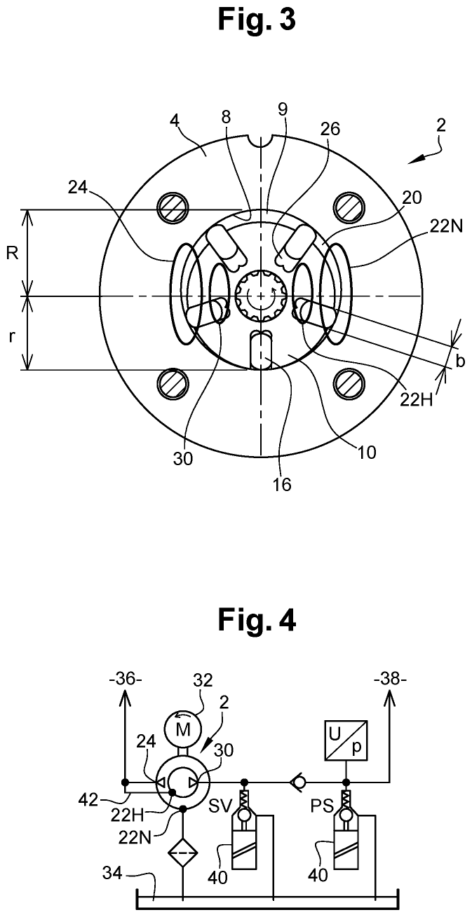

FIG. 3 shows, in a cross-sectional view, a rotary vane pump according to a second embodiment of the invention;

FIG. 4 shows, in a hydraulic circuit diagram, the rotary vane pump according to the second embodiment in an exemplary application;

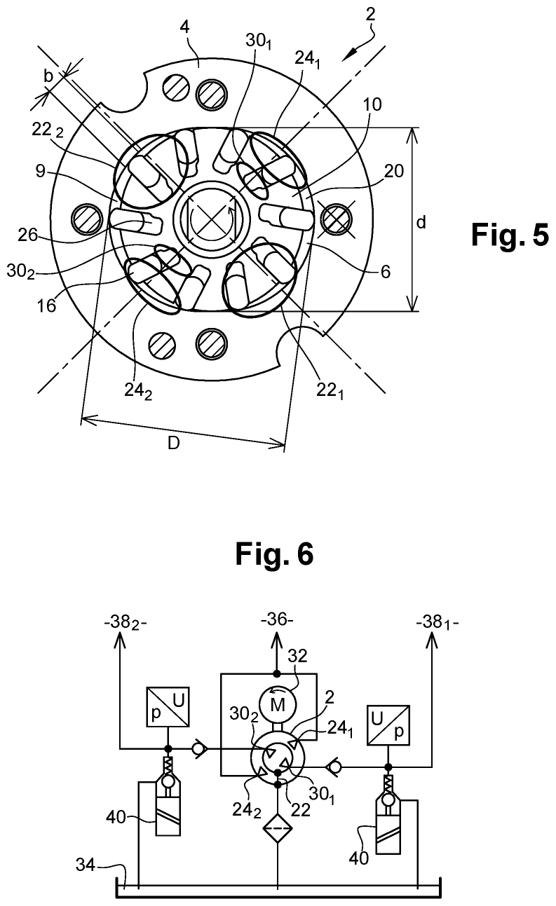

FIG. 5 shows, in a cross-sectional view, a rotary vane pump according to a third embodiment of the invention;

FIG. 6 shows, in a hydraulic circuit diagram, the rotary vane pump according to the third embodiment in an exemplary application;

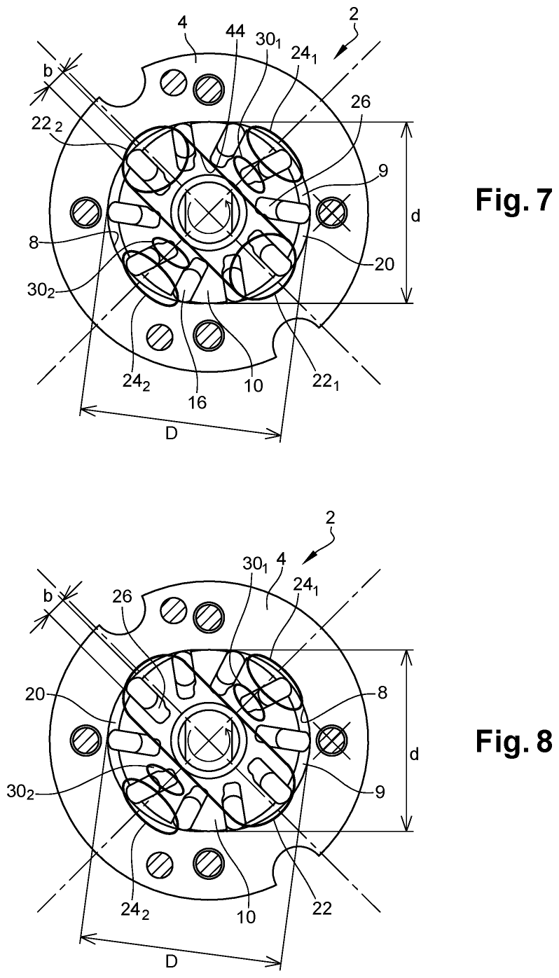

FIG. 7 shows a first embodiment variant with respect to the third embodiment of the rotary vane pump; and

FIG. 8 shows a second embodiment variant with respect to the third embodiment of the rotary vane pump.

FIG. 1 schematically shows a rotary vane pump 2 in a cross section. It has a stator 4 in which there is formed an interior space 6 which is surrounded by an inner wall 8.

A rotor 10 is arranged in the interior of the stator 4 and is mounted on a shaft 12 and can be driven by the latter.

The rotor 10 is provided with multiple receptacles 14, in which in each case one rotary vane 16 is received.

The receptacles 14 extend in the axial direction normally from a face side of the rotor 10 as far as the opposite face side, and from the outer periphery of the rotor inwards. In the exemplary embodiment shown, the receptacles 14 extend in the radial direction. This is not necessary, however.

Here, the rotary vanes are in the form of plates whose dimension in the radial direction is slightly less than the radial depth of the receptacles 14. Each of the plates has a thickness b, which corresponds to the width of the receptacles 14.

As an alternative to plate-like rotary vanes, use may also be made of rotary vanes which are in the form of a cylinder.

The rotor 10 has a diameter of 2*r (minus a clearance between rotor and stator that is to be provided in the design), which is less than the diameter r+R of the interior space 6 of the stator 4. The rotor 10 is arranged eccentrically in the interior space, specifically such that it is (almost) in contact with the inner wall 8 on one side (at the 6 o'clock position in this case), with the result that the maximum spacing to the outer wall of the rotor 10 is on the diametrically opposite side.

The rotary vanes 16 bear with their radially outer side 18 permanently against the inner wall 8 of the stator 4 (at any rate when the rotor 10 is rotating). Consequently, between rotary vanes 16 adjacent to one another in the peripheral direction, the inner wall 8 of the stator 4, the outer wall of the rotor 10 and two side walls which close off the interior space 6 at the face sides of the rotor 10 (and of which only the “rear” side wall 9 can be seen here), in each case one low-pressure chamber 20 is delimited.

In the exemplary embodiment shown, there are, since five rotary vanes 16 are present, also five low-pressure chambers 20 formed. The volume of each individual low-pressure chamber, for one rotation of the rotor 10 through 360°, changes from a minimum value (when the low-pressure chamber 20 is approximately at the 6 o'clock position) via a maximum value (when the low-pressure chamber 20 is approximately at the 12 o'clock position) and back to the minimum value.

Hydraulic fluid is fed to the low-pressure chambers 20 through an inlet opening 22. Said inlet opening, as seen in the direction of rotation of the rotor 10, is situated behind the point at which the spacing between the outer surface of the rotor 10 and the inner wall 8 of the stator 4 is minimal.

The hydraulic fluid drawn in by the low-pressure chambers 20 via the inlet opening 22 is delivered via a low-pressure outlet opening 24, which, as seen in the peripheral direction, is behind the position at which the low-pressure chambers 20 have the maximum volume, but in front of the position at which the spacing between the outer side of the rotor 10 and the inner wall 8 of the stator 4 is minimal.

The inlet opening 22 and the low-pressure outlet opening 24 are arranged here in one of the side walls 9 of the rotary vane pump 2 or else, so as to improve the filling, in both side walls 9, so that the hydraulic fluid can be drawn into the low-pressure chamber 20, and pushed out therefrom, from both sides.

Each of the rotary vanes 16 delimits together with the rotor 10 (and also the side walls 9) in each case one high-pressure chamber 26. Specifically, each radially inner side 28 of each rotary vane 16 delimits together with the walls of the receptacle 14 and the side walls 9 shown in each case one high-pressure chamber 26.

The volume of the high-pressure chambers 26 changes according to the displacement of the rotary vanes 16 in the receptacles 14. When the rotary vanes 16 move outwards (that is to say during a movement from the 6 o'clock position to the 12 o'clock position via the 3 o'clock position in the exemplary embodiment shown), the volume of the high-pressure chambers 26 increases, and when the rotary vanes 16 move inwards (that is to say during a movement from the 12 o'clock position to the 6 o'clock position via the 9 o'clock position), the volume decreases.

In this way, there is formed a piston pump in which the radially inner side 28 of each rotary vane 16 may be regarded as the face surface of a pump piston which is adjusted by means of a curved path (of the inner wall 8 of the stator 4). For drawing-in, the pump piston is adjusted outwards under the action of centrifugal force, and for pushing-out, the pump piston is displaced inwards owing to the contour of the inner wall 8 of the stator 4.

The high-pressure chamber 26 draws in via the same inlet opening 22 as that which provides a supply to the low-pressure chambers 20.

A high-pressure outlet opening 30 which is separate from the low-pressure outlet opening 24 is provided on the pressure side of the high-pressure pump. In the peripheral direction, said high-pressure outlet opening is arranged approximately at the same position as the low-pressure outlet opening 24.

The high-pressure outlet opening 30 may be provided either at only one side wall 9 of the stator 4 (and thus also of the rotor 10) or at both sides.

FIG. 2 shows an application example for the rotary vane pump 2 in FIG. 1.

The rotary vane pump 2 is driven by a motor 32 and draws out of a schematically shown storage vessel 34. The motor 32 is an electric motor. More particularly, the rotor 10 of the rotary vane pump 2 is moved into rotation by the motor 32. The low-pressure outlet opening 24 serves for providing a supply to a lubricant circuit 36. The high-pressure outlet opening 30 serves for actuating an actuator 38. For this purpose, different control or regulating valves 40 may be arranged in between.

FIG. 3 shows a second embodiment of the rotary vane pump. The same reference signs are used for the components known from the first embodiment, and, to this extent, attention is drawn to the above explanations.

The difference between the first and second embodiments is that, in the second embodiment, two separate inlet openings, specifically a low-pressure inlet opening 22N and a high-pressure inlet opening 22H, are used on the suction side.

As can be seen in FIG. 4, only the low-pressure inlet opening 22N is connected to the storage vessel 34. The high-pressure inlet opening 22H, by contrast, is provided with a supply via a branch 42 from the low-pressure outlet opening 24.

The advantage of this configuration is that the hydraulic fluid is fed to the high-pressure inlet opening 22H at positive pressure, with the result that said hydraulic fluid can fill the high-pressure chamber 26 more effectively. Moreover, it is ensured that the rotary vanes 16 reliably bear against the inner wall 8 of the stator 4 even in the case of low rotational speeds of the rotary vane pump 2.

FIG. 5 shows a third embodiment of the rotary vane pump. The same reference signs are used for the components known from the preceding embodiments, and, to this extent, attention is drawn to the above explanations.

The embodiment shown in FIG. 5 is based in principle on the embodiment shown in FIG. 1, which has a common inlet opening 22 both for the low-pressure chambers 20 and for the high-pressure chambers 26 and two separate outlet openings, specifically a low-pressure outlet opening 24 and a high-pressure outlet opening 30.

The difference with respect to the first embodiment is that the embodiment as per FIG. 5 has a double-stroke or two-flow structure. Here, the interior space 6, as seen in cross section, is slightly elongate with a longer diameter D, which is greater than the diameter d of the rotor 10, wherein said diameter d corresponds to the shorter diameter d of the interior space. Accordingly, each rotary vane 16 is displaced outwardly and inwardly twice during a rotation of the rotor 10 through 360°. Thus, with regard to the high-pressure pump, each “pump piston” (rotary vane 16) performs two pump strokes during a rotation of the rotor 10 through 360°.

Accordingly, two inlet openings 22₁, 22₂ are provided, and there are two low-pressure outlet openings 24₁, 24₂ and two high-pressure outlet openings 30₁, 30₂.

It may also be mentioned in passing that, in the embodiment in FIG. 5, the central plane of the receptacles 14 no longer extends through the axis of rotation of the rotor 10, but rather the plane of the rear side walls of the receptacles 14 as seen in the direction of rotation extends therethrough.

FIG. 6 illustrates an application example for the pump 2 shown in FIG. 5. The two high-pressure outlet openings 30₁, 30₂ serve for providing a supply to two actuators 38₁, 38₂.

The two low-pressure outlet openings 24₁, 24₂ jointly serve for providing a supply to a coolant circuit 36.

FIG. 7 illustrates a variant with respect to the third embodiment, which is shown in FIG. 5. The same reference signs are used for the components known from the preceding embodiments, and, to this extent, attention is drawn to the above explanations.

The difference between the variant shown in FIG. 7 and the embodiment shown in FIG. 5 is that, in the variant shown in FIG. 7, the two inlet openings 22₁, 22₂ are provided with a supply via a central channel 44 (shown schematically here), which is provided in one of the side walls 9 of the rotary vane pump 2 (preferably on the side facing away from the motor 32). This reduces the complexity on the suction side.

FIG. 8 shows a second variant with respect to the third embodiment. The same reference signs are used for the components known from the preceding embodiments, and, to this extent, attention is drawn to the above explanations.

The difference between the variant shown in FIG. 8 and the variant shown in FIG. 7 is that, in the variant in FIG. 8, the channel 44 is open with respect to the face side of the rotor 10, with the result that a common inlet opening 22 extending diametrically over the entire face side of the rotor 10 is formed. This makes it possible to receive an axial leakage flow and thus to reduce axial loads on the rotor 10.

1. A rotary vane pump having a stator and having a rotor wherein at least one rotary vane is received, wherein a radially outer side of the rotary vane serves for delimiting a low-pressure chamber, and wherein a radially inner side of the rotary vane serves for delimiting a high-pressure chamber.

2. The rotary vane pump according to claim 1, wherein the stator has two side walls, and wherein, in at least one of the side walls, provision is made of a high-pressure outlet opening, which is assigned to the high-pressure chamber.

3. The rotary vane pump according to claim 2, wherein, in at least one of the side walls, provision is made of an inlet opening, which is assigned to both the low-pressure chamber and the high-pressure chamber.

4. The rotary vane pump according to claim 2, wherein, in at least one of the side walls, provision is made of a high-pressure inlet opening, which is assigned exclusively to the high-pressure chamber, wherein provision is made of a low-pressure inlet opening, which is separate from the high-pressure inlet opening and is assigned exclusively to the low-pressure chamber.

5. The rotary vane pump according to claim 4, wherein the low-pressure inlet opening is provided in at least one of the side walls.

6. The rotary vane pump according to claim 4, wherein a branch leads from a low-pressure outlet opening to the high-pressure inlet opening.

7. The rotary vane pump according to claim 1, wherein the stator has an inner wall whose radius, as seen in a cross section of the stator and with respect to the axis of rotation of the rotor, increases from a minimum to a maximum, and then decreases again to the minimum, in the circumferential direction, wherein, as seen over an angle of 360°, there is exactly one minimum and exactly one maximum.

8. The rotary vane pump according to claim 1, wherein the stator has an inner wall whose radius, as seen in a cross section of the stator and with respect to the axis of rotation of the rotor, increases from a minimum, then decreases again, then increases again, and then decreases once more, over an angle of 360° in a revolution in the circumferential direction.

9. The rotary vane pump according to claim 8, wherein provision is made of a common inlet opening for two pump chambers, which extends on a side wall, diametrically from one side to the other side.

10. The rotary vane pump according to claim 1, wherein the rotary vane is a plate.

11. The rotary vane pump according to claim 1, wherein the rotary vane is a cylinder.

12. The rotary vane pump according to claim 1, wherein provision is made of five or more rotary vanes.

13. The rotary vane pump according to claim 1, wherein the rotor of the rotary vane pump is moved into rotation by an electric motor.
